(19) United States
(12) Patent Application Publication
(10) Pub. No.: US 2011/0048579 A1
(43) Pub. Date: Mar. 3, 2011

(54) Tree trimmer telescopic

(76) Inventor: John L. Robitaille, Glastonbury, CT (US)

(21) Appl. No.: 12/583,893

(22) Filed: Aug. 27, 2009

(51) Int. Cl. A01G 23/095

(52) U.S. Cl. 144/24.13; 30/379.5

(57) ABSTRACT

A mechanism designed to remove difficult to reach overhead tree branches. All power is derived from a standard 120 volt AC outlet. It is pneumatically controlled in 2- axes thru a main column containing one or a plurality of concentric cylinders and a separate air cylinder for height and elevation control. An electric powered saw is mounted at the end of the highest telescoping section. A pressure/vacuum pump provides the required force.

Mobility is facilitated by three wheels, one of which is used to steer and position the saw into place for cutting. A control panel contains two pairs of pneumatic directional and pressure regulating valves for position control of a motorized saw blade by way of control over a main column and air cylinder.

Power requirements are derived from common household AC power. The extension of the main column and position of the saw blade is achieved through the use of compressed air. Accurate positioning is achieved thru the use of pressure regulators to the main column and air cylinder. Retraction of the main column is accelerated through the use of a vacuum pump. After use, the air cylinder can be pinned in a stow position against the main column. The saw blade and guide assembly can be re-indexed to one of four separate orientations for optimal cutting position. Also the saw guide is reserved for smaller flexible tree branches. It works in concert with the blade teeth to facilitate the quick removal of branches so as to prevent their deflection when the spinning blade comes into contact.

### REFERENCE NUMERALS IN DRAWINGS

1 Main View
2 Column Lock
3 Front and Rear Base Support
4 Control Panel
5 Circular Saw
6 Chain Saw

### DESCRIPTION OF THE DRAWINGS

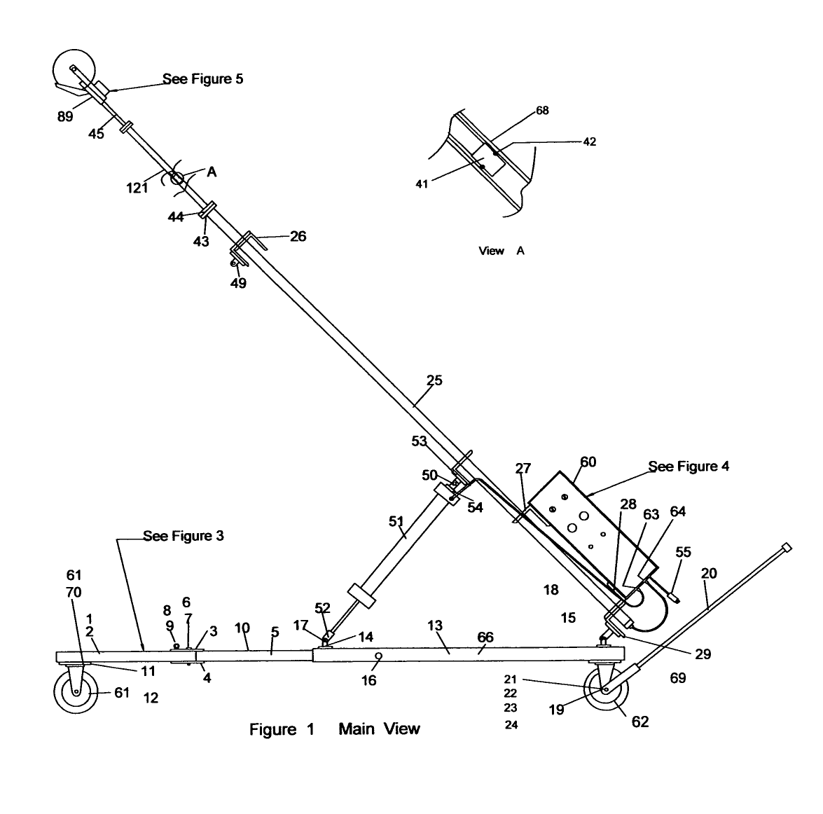

FIG. 1 depicts a View of all the subassemblies that comprise the tree trimmer.

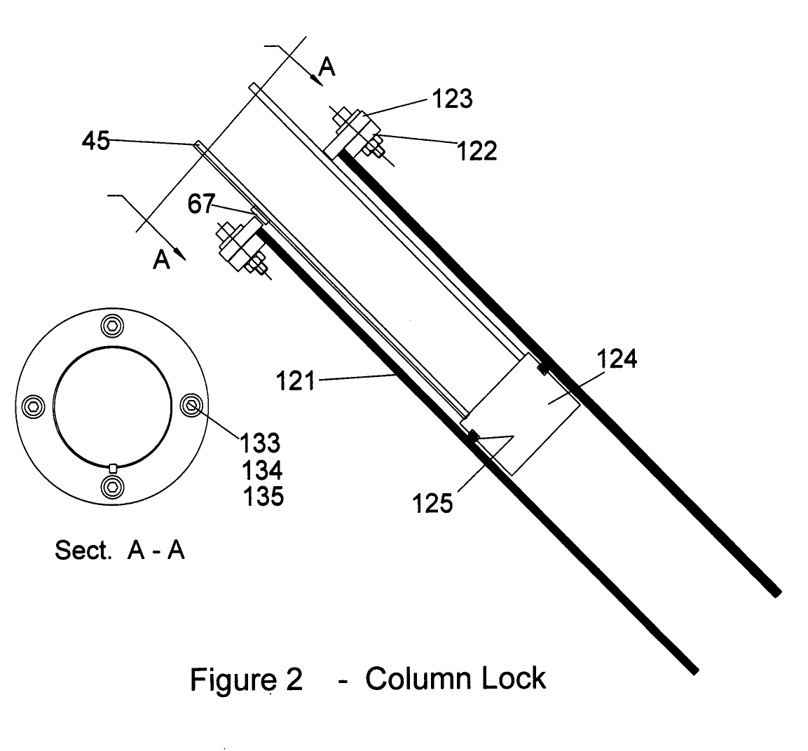

FIG. 2 depicts the design for additional columns, and their interlocking keyways.

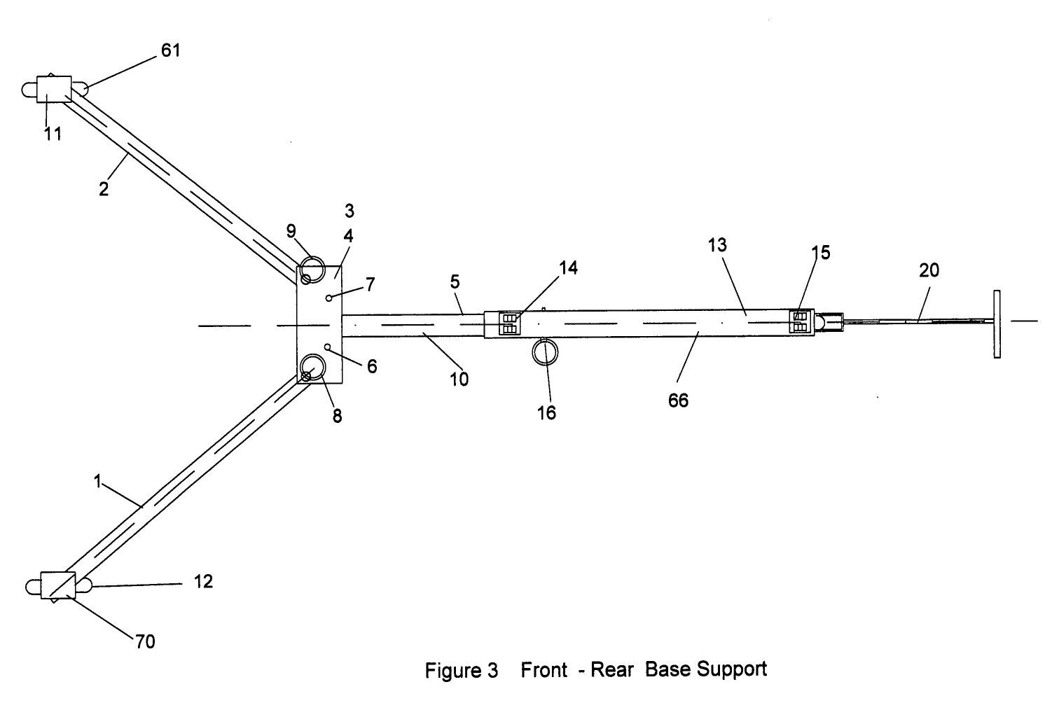

FIG. 3 depicts the Front and Rear Base Support.

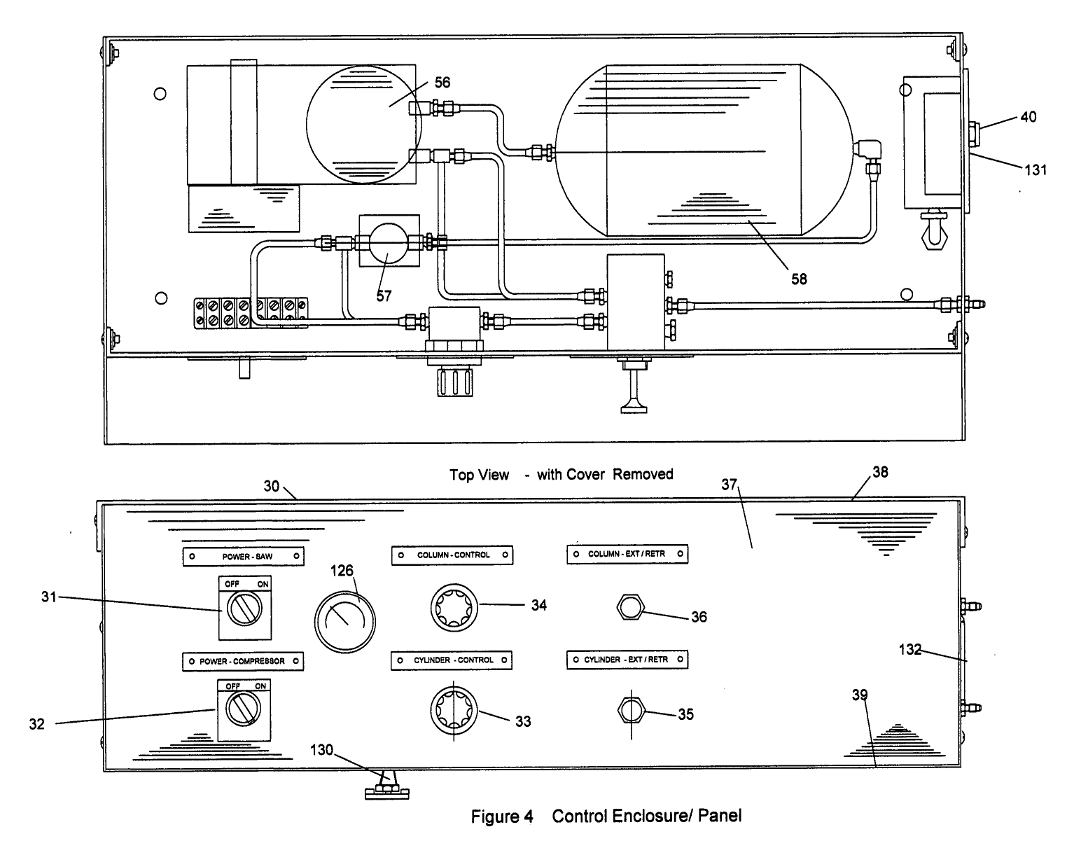

FIG. 4 depicts the Control Enclosure/Panel.

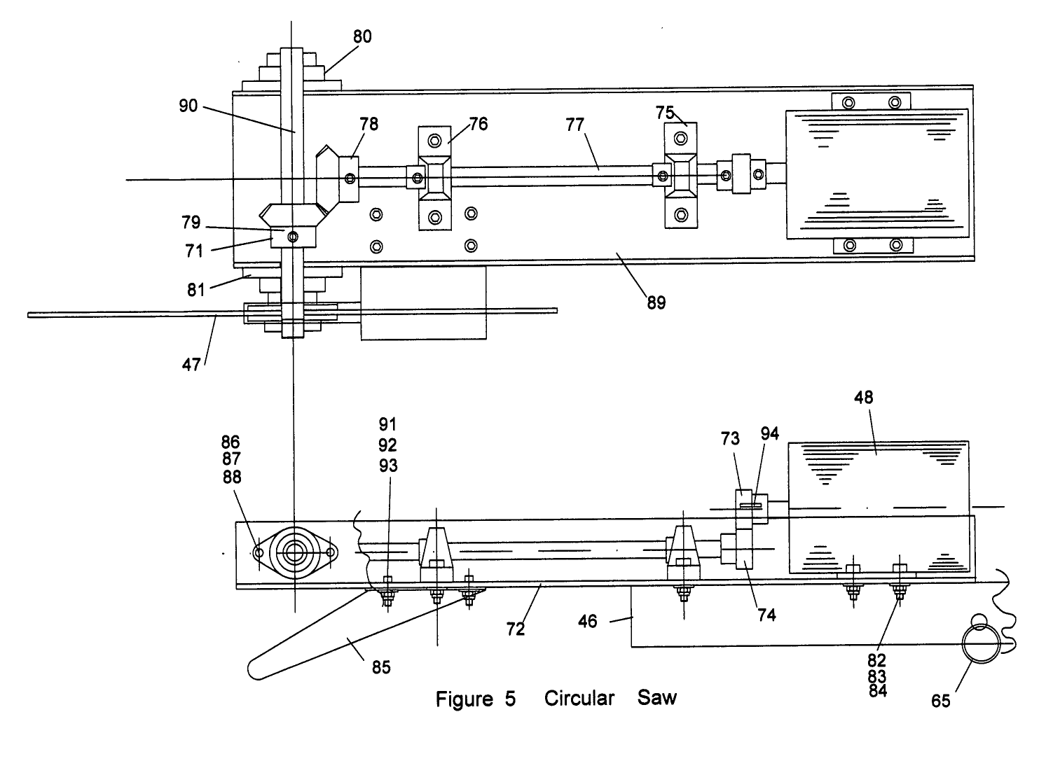

FIG. 5 depicts the Circular Saw attachment used for small branches.

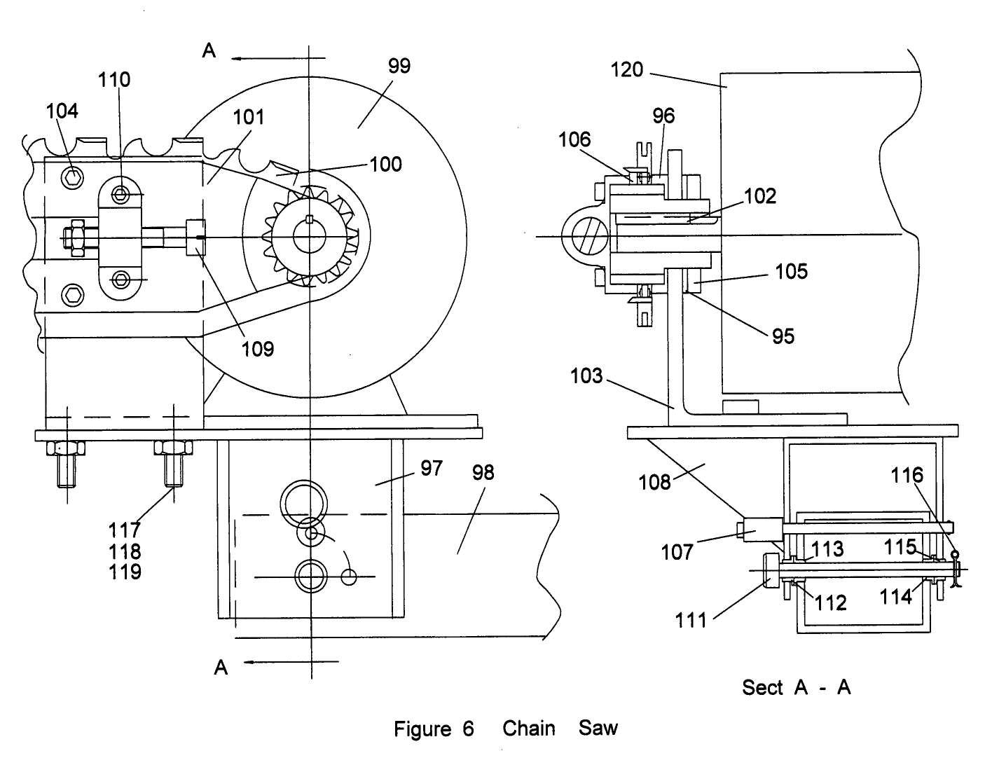

FIG. 6 depicts the Chain Saw attachment used for large branches.

### DETAILED DESCRIPTION OF THE INVENTION

Referring to the drawings, in general there is shown the preferred embodiment for the Tree Trimmer. The Tree Trimmer 60 consists of four subassemblies: main column 25, front base 10, rear base 66 and saw assembly 89.

The Tree Trimmer 60 of this invention is a pneumatically operated extendable column operable from household 120 Volt AC power. The Tree Trimmer 60 can be readily disassembled and deployed in locations not normally accessible by most conventional tree trimmers. In the preferred embodiment the main column 25 which consists of a control panel 37 and control panel assembly 30 that contains the components used to elevate the saw support column 45, namely an air compressor/vacuum pump 56, air filter 57, air tank 58 and required air valves and regulation as described below. A separate drain valve 130 is used to remove water from the air filter 57. The control panel 37 has two separate sets of controls for the air cylinder 51 and the main column 25. Power to the saw is controlled through a power switch 32, while power to the compressor/vacuum pump is controlled thru power switch 31. Both of these power switches are located on the control panel 37. All components within the control panel assembly 30 are protected from the elements by a control panel cover 38. The control panel cover 38 and the components within the control panel assembly 30 are secured to the control panel base plate 39. The extension and retraction of the saw support column 45 is controlled thru the use of a main column directional control valve 36, and a main column pressure regulator 35. Pressure and vacuum to the main column 25 are supplied via the main column air supply line 64 and in turn verified by a pressure gauge 126. While the angle of the main column 25 relative to the bottom plane reference, formed by the three wheels 11, 12 and 62 is controlled thru the use of the air cylinder directional control valve 34. The force to air cylinder 51 is controlled thru the air cylinder pressure regulator 33. Pressure and vacuum to the air cylinder 51 are supplied via the air cylinder supply line 63.

The reach pivot bracket 49 is secured to the reach support bracket 26, which in turn is welded to the main column 25. The reach pivot bracket 49 is used for the attachment of the air cylinder 51, via air cylinder clevis bracket 50, when used in the reach mode or to extend the saw blade 47 to tree branches in the horizontal direction.

The height pivot bracket 53 is secured to the height support bracket 27 which is welded to the main column 25. The height pivot bracket 53 is secured to the height support bracket 27, which in turn is welded to the main column 25. The height pivot bracket 53 is used for attachment of the air cylinder 51 via the air cylinder clevis bracket 50 when used in the height mode or to extend the saw blade 47 to tree branches in the vertical direction. The rod end of the air cylinder 51 has a clevis bracket 52 that is attached to the front pivot bracket 14.

The saw support column 45 is made of solid round stock and welded to the saw column sleeve 124. Compressed air is used to extend the saw column 45 and a seal is maintained between the second column extension sleeve 41 and main column 25 by a second column O-ring 42 on the second column sleeve 41.

An extension guide plate 44 resists the rotation of the saw support column 45 thru use of a saw support column guide key 67, which is secured to the saw support column 45. An external main column retention plate 43 is welded to the main column and is used for the attachment of the extension guide plate 44.

### Second Column

The second column 121 is a round aluminum tube and welded to the saw column sleeve 124. Compressed air is used to extend the second column 121 while a seal is maintained between the saw column sleeve 124 and main column 25 by a saw column O-ring 125 on the saw column sleeve 124.

A saw column retention plate 122 is welded to the second column 121, while saw column guide plate 123 works in concert with the saw support column guide key 67, of the saw column 45 to prevent roll movement of the circular saw blade 47. The saw column retention plate 122 is secured to the saw column guide plate 22 by four bolts 133, nuts 134 and washers 135.

A main column guide plate 44 resists the rotation of the second column 121 thru use of a second column guide key 68, which is secured to the second column 121. An external main column retention plate 43 is welded to the main column and is used for the attachment of the extension guide plate 44.

The main column clevis bracket 69 is secured to the rear main column support bracket 28, which is welded to the main column 25. This is the main column pivot point. A rear cap 29 is welded to the bottom of the main column 25. At the bottom of the main column is provided a water drain plug 54 to allow the discharge of water that may build-up within the main column 25.

In the preferred embodiment power to the Tree Trimmer 60 is provided thru the main power cord 55, while power to the saw motor is sent via a power cord 59. An electrical compression fitting 131 is installed at the base of the control panel assembly 30 to provide strain relief to the main power cord 55. Electrical power to the electric motor 48 used to rotate the saw blade 47 is provided for by a weather proof power receptacle 40 located at the end of the control panel assembly 30, while a weather proof cover 132 minimizes intrusion of the elements. This allows for quick detachment of various saw bracket combinations. A circular saw assembly 89 consisting primarily of a saw base 72 is retained to the saw support column 45 through the use of a retention pin 65. Two holes within the saw support column 45 permits the saw base 72 to reposition the saw blade 47 in four distinct orientations for an optimal cutting angle.

The front base subassembly 10 consists of three supporting elements the left front support base 2, the right front support base 1 and the main front support base 5. Two pivot plates, a top pivot plate 3 and a bottom pivot plate 4 secured to the main front support base 5 function as clevis brackets for the left front support base 2 and the right support base 1. These two elements are each separately secured with a left front clevis pin 7 and a right front clevis pin 6 respectively. The Front Base subassembly 10 is designed for quick stowage by removing both the left front retention pin 9 and the right front retention pin 8.

Both the left front support base 2 and the right front support base leach have a separate left front wheel 11 and a right front wheel 12. These tires are pneumatic and are attached to two welded plates—left front wheel mounting plate 61 and right front wheel mounting plate 70.

Stability and lateral support is assured by the fixed position of the left front wheel 11 and right front wheel 12. The subtended angle formed between the elements supporting the left front wheel 11 and the right front wheel 12 is determined by the location of the left front retention pin 9 and the right front retention pin 8.

The rear base subassembly 66 consist of a rear base 13 that is a square tubular frame element that engages with a smaller front support 5 tubular member and retained in place with a quick release retention pin 16.

The front support 5 has a front pivot bracket 14 which accepts the telescoping end of the air cylinder 51. It is retained in position by a quick release retention pin 17. The front support also has a rear pivot bracket 15 that accepts the main column clevis bracket 69. The main column clevis bracket 69 is retained in position by a quick release retention pin 18.

A rear pivot wheel 62 is adjoined to a swivel plate which is secured to the underside of the rear base 13. The rear wheel in conjunction with a rear handle 20 permits the steering and positioning of the tree trimmer 60.

The rear pivot wheel 62 is secured with an axle pin 19 and is pivoted by a rear handle 20. The rear wheel axle pin 19 is secured in place with a nut 22, two washers 23 and a cotter pin 24.

### Circular Saw Attachment

A circular saw assembly 89 is designed for removal of small branches and attaches to the end of the saw support column 45 thru the circular saw attachment guide 46 with a quick release retention pin 65. A circular saw base 72 is integral with the circular saw attachment guide 46 and supports a circular saw electric motor 48. The electric motor 48 is secured to a circular saw base 72 with four bolts 82, nuts 83 and washers 84 and supports a motor spur gear 73 which drives a driveshaft spur gear 74 that is attached to the main drive shaft 77. The main drive shaft 77 is supported by an upper pillow block bearing 75 and lower pillow block bearing 76. These in turn are secured by two bolts 86, nuts 87 and washers 88. The main drive shaft 77 translates motion to a cross shaft 90, which supports a circular saw blade 47. Power transfer is done thru a drive miter gear 78 and rotates a cross shaft miter gear 79 that is attached to the cross shaft 90. Two sets of keyways, miter gear keyways 71 for the two miter gears 78 and 79 and two spur gear keyways 94 for the spur gears 73 and 74 are used to prevent rotation of the respective gears.

The cross shaft 90 is supported by a left cross shaft bearing 80 and a right cross shaft bearing 81.

A branch guide 85 is part of the circular saw assembly 89 and provides a means to guide smaller branches into the rotating circular saw blade 47. It is secured in place by four bolts 91, nuts 92, and washers 93.

### Chain Saw Attachment

A chain saw assembly 120 is designed for removing large branches and can be quickly attached to the end of the saw support column 45 with a quick release retention pin 65. A chain saw electric motor 99 is secured to a base plate 96 by four bolts 117, nuts 118 and washers 119, The base plate 96 is supported by a swivel bracket 97 and swivel bracket gussett 108. The swivel bracket 97 pivots on a support column 98, which is attached to the support column 45.

By removing a quick release retention pin 107 the chain saw assembly 120 can rotate about a swivel pin 111 to one of a plurality of positions for an optimal cutting angle. Also the chain saw assembly 120 can rotate about the saw support column 45 to one of two angular positions. The quick release pin 107 is guide by a washer 109 and guide bushing 110 within the swivel bracket 97.

The chain saw swivel pin 111 is guided and supported by a motor support left bushing 112, box support left bushing 113, box support right bushing 114 and a motor support right bushing 115. The swivel pin 111 is positioned in place with a cotter pin 116.

To preclude loosening of the saw bar 101, a chain bar bracket 103 and bracket lock plate 106 are secured with two bolts 104, nuts 105, and washers 95. A tighten screw 127 can be adjusted to remove saw chain looseness. This is used with a tighten nut 129 to assure anti-rotation of the tighten screw 127. A washer 128 is also used with both the tighten screw 127 and nut 129.

The chain saw assembly 120 consists of a saw bar 101, and a saw chain 100 which is driven by a chain saw sprocket 102 and is secured to the shaft of the electric motor 99.

I claim:

1. A telescopic tree trimmer comprising:
1. The preferred embodiment has a plurality of pneumatically controlled concentric columns within the main column that can be extended for height and reach access to tree branches.
2. A tree trimmer according to claim 1, further consisting of keyed/guided columns that engage with the prior columns to preclude rotation.
3. A tree trimmer as in claims 1 and 2, further comprising of a vacuum pump whose purpose is to retract the cylinders in claim 1 with one pneumatic line.
4. A tree trimmer as in claims 1 and 2 further comprises of an air cylinder that provides additional height and extension control.
5. A tree trimmer as in any of the claims 1, 3 and 4 further comprising two pneumatic directional control valves and two pressure regulating valves for the purpose of height and extension control.
6. A tree trimmer as in any of the preceding claims whose complete mechanism is supported on 3 pneumatic tires (2 fixed and 1 rear swivel tire) to simplify conveyance of such.
7. A tree trimmer as in any of the preceding claims has a removable electric powered Circular Saw or Chain Saw.
